(19) United States
(12) Patent Application Publication
(10) Pub. No.: US 2010/0083844 A1
(43) Pub. Date: Apr. 8, 2010

(54) Brewing unit for a coffee machine and coffee machine comprising such a brewing unit

(75) Inventor: Rüdiger Budweg, HERNE (DE)

Correspondence Address: Oppedahl Patent Law Firm LLC (P&A), P O Box 5940, Dillon, CO, 80435-5940, US

(73) Assignee: WIK FAR EAST LTD., North Point (HK)

(21) Appl. No.: 12/594,257

(22) PCT Filed: Apr. 21, 2008
(86) PCT No.: PCT/EP08/54803

§ 371 Date: Nov. 16, 2009

(30) Foreign Application Priority Data
Apr. 21, 2007 (DE) 20 2007 005 791.1

(51) Int. Cl. A47J 31/36

(52) U.S. Cl. 99/302 P; 99/289 R

(57) ABSTRACT

A brewing unit (1) for a coffee machine includes a brewing cylinder (2) comprising two plungers (4, 5). At least one of these elements (2, 4, 5) is movable relative to the others by means of a spindle drive (6) in order to form a brewing chamber within the brewing cylinder (2). The spindle drive (6) has a spindle (9) and an output-side element (10) engaging with the thread of the spindle (9). The brewing unit (1) has an electric motor forming one structural unit with said brewing unit. Therefore, the brewing unit may be inserted into a coffee machine as a single unit with its electric motor, may also be removed therefrom.

### BACKGROUND

The present disclosure relates to a brewing unit for a coffee machine, the brewing unit having a brewing cylinder with two pistons wherein at least one of these elements is movable relative to the others by means of a spindle drive. The spindle drive has a spindle and an output element engaged with the threads of the spindle to form a brewing chamber within the brewing cylinder. The invention furthermore relates to a coffee machine equipped with such a brewing unit.

Coffee machines than can prepare freshly brewed coffee in portions, for example cup by cup, are equipped with a brewing unit. The brewing unit has a brewing cylinder that the ground coffee powder flows into and is compressed at the start of a brewing cycle. Hot water then is run through the ground coffee before the depleted coffee grinds are ejected from the brewing cylinder. The coffee powder is often freshly ground from coffee beans in a grinding mechanism attached to the coffee machine just before being put into the brewing cylinder. Depending on the design of the brewing unit, the grinding mechanism may have at least two movable elements. The movable elements may be two pistons that move relative to the other, or a piston and the brewing cylinder. In some prior art brewing units, the two pistons as well as the brewing cylinder are all movable relative to each other.

WO 02/09563 A1 and EP 0 659 377 B1 both disclose brewing units where the brewing cylinder is driven by means of a spindle drive. The movement of one of the pistons is coupled to the movement of the brewing cylinder while the other piston is stationary. These prior art spindle drives have a threaded spindle with an output element that is rotationally uncoupled relative to the rotational motion of the threaded spindle. The spindle is driven by an electric motor. The output element is moved in either of the axial directions of the spindle, depending on the rotational direction of the spindle. The brewing cylinder in turn is connected to the output element. In the brewing unit described in WO 02/09563 A1, the output element is a distance in an axial direction from the brewing cylinder and connected to the latter by means of drive rods. In the brewing unit of EP 0 659 377 B1, the brewing cylinder is integrally molded to the output element.

In both these coffee machines, the electric motors that drive the spindle are part of the coffee machine. In EP 0 659 377 B1, to remove the brewing unit from the coffee machine the spindle has a coupling stud that engages in torque-fitting fashion with a drive element in coffee machine. To maintain the synchronization between the control device of the coffee machine and the position of the movable elements of the brewing unit, the drive spindle should not be rotated when the brewing unit has been removed from the coffee machine. However, this cannot always be avoided during the intended cleaning of the brewing unit.

The brewing unit of WO 02/09563 A1 address this issue by having the drive rods interface brewing cylinder such that the brewing cylinder, the accompanying piston and the coffee outlet can be removed from the coffee machine together. However, the provision of such an interface with the drive rods is costly.

An additional disadvantage of this prior art brewing unit it that they require significant installation depth. This is particularly relevant when the brewing unit is horizontally aligned in the direction of the depth of the coffee machine, and in particular when it is to be inserted into or removed from the coffee machine in this direction.

Therefore, starting from this discussed state of the art, the invention is based on the objective of further improving a brewing unit mentioned at the beginning to the effect that the disadvantages shown in connection with the aforementioned brewing units are avoided to the greatest extent possible.

The foregoing example of the related art and limitations related therewith are intended to be illustrative and not exclusive. Other limitations of the related art will become apparent to those of skill in the art upon a reading of the specification and a study of the drawings.

### SUMMARY

One aspect of the invention is a brewing unit and an electric motor formed as a structural unit so that the brewing unit together with its electric motor can be inserted into and removed from a coffee machine as a single unit.

The following embodiments and aspects thereof are described and illustrated in conjunction with systems, tool and methods which are meant to be exemplary and illustrative, not limiting in scope. In various embodiments, one or more of the above described problems have been reduced or eliminated, while other embodiments are directed to other improvements.

In contrast with the prior art, the electric motor is an integral component of the brewing unit. This brewing unit is therefore a complete module that can be inserted into and removed from a coffee machine as a single unit. In this design, the electric motor can be located radially to the actual brewing unit, thereby not adding depth to the required installation space. Transmission of power from the drive shaft of the electric motor to the spindle can be done via pinions, a chain or a belt, for example a tooth belt. All of these power transmissions require very little space in the longitudinal extension of the brewing unit. This means that the coffee machine can have less depth and still allow the brewing unit into to be inserted the coffee machine in horizontal direction from front to rear and to remove it from in the opposite direction. The transmission elements can be enclosed in a drive gear box.

An additional advantage of designing the electric motor as a component of the brewing unit is provided in the event of maintenance work. This allows a brewing cycle to be run easily by supplying current to the electric motor, even when the brewing unit is not in the coffee machine.

In accordance with a preferred embodiment, the discharge-side piston is moveable through the brewing cylinder along the longitudinal axis while the other piston is fixed. The fixed piston closer to the spindle is deeper inside of the coffee machine than the other piston with its coffee discharge line when the brewing unit is inserted into the coffee machine. This is an advantage with a hot water supply line that is attached to the fixed piston, since no movable elements are required as a matter of principle. It is possible to provide a hot water supply line to the fixed piston from a radial direction as well.

In accordance with another preferred design, the output element comprises a threaded sleeve that engages with the threaded spindle. The threaded spindle is mounted in the output element in the direction of the longitudinal axis and movable by a certain amount relative to the output element against the force of a spring element. The cushioning element has a spring element whose spring force determines the amount of cushioning effect. Typically, one will use a spring element, preferably a helical compression spring, whose maximal spring force is greater than the maximal force exerted on the output element by the spindle drive without being extended to a blocked position. By arranging the cushioning element as part of the output element, preferably within it, allows the cushioning element to be designed such that it will effectively operate in both directions. This allows the one cushioning element to cushion the blocking contact both of the final positions of the moved element, for example of the brewing cylinder. This further reduces the length of such a brewing unit.

In another possible element of this design, two adjusting rings are movably arranged on the external shell surface along the longitudinal axis of the threaded sleeve to form the cushioning element. Each of the adjusting rings have a radially projecting flange. The two flanges support a helical compression spring as the spring element. Thus, the helical compression spring presses the two adjusting rings away from each other. Since the flanges are arranged within a chamber of the output element, the maximal distance between the adjusting rings is limited by the contact of the flanges with a chamber wall. The threaded sleeve has impact projections reaching outward in axial direction in the area of its two ends or directly at one end. The latter serve to contact with the front end of an adjusting ring. Preferably, the adjusting rings contact the corresponding impact projections of the threaded sleeves in neutral position of the cushioning element. The two adjusting rings are at a distance from each other so that one or the other adjusting ring is moved in the direction of the longitudinal axis relative to the output element against the force of the spring element depending on the direction of the relative movement of the threaded sleeve. This measure provides a cushioning element working in both directions in a small space. The output element described above, together with its cushioning element, can also be used in conventional brewing units that have a spindle drive but are not equipped with an electric motor as an integral component of the brewing unit.

In addition to the exemplary aspects and embodiments described above, further aspects and embodiments will become apparent by reference to the accompanying drawings forming a part of this specification wherein like reference characters designate corresponding parts in the several views.

### BRIEF DESCRIPTION OF THE DRAWINGS

FIG. 1 is a schematic representation of a longitudinal cut of a brewing unit for a coffee machine comprising a spindle drive.

FIG. 2 is a perspective view of the brewing unit of FIG. 1.

FIG. 3 is a cross sectional representation of the brewing unit of FIG. 1 along the A-B line of FIG. 1.

FIG. 4 is an enlarged representation of a detail of the spindle drive of the brewing unit of FIG. 1 in neutral position of its cushioning element.

FIG. 5 is a schematic view of the spindle drive shown in FIG. 2 in a position in which the brewing cylinder moved by the spindle drive has made contact with a first stop.

FIG. 6 is a schematic view of the spindle drive shown in FIG. 2 in a position in which the brewing cylinder moved by the spindle drive has made contact with its opposite stop.

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION OF THE DRAWINGS

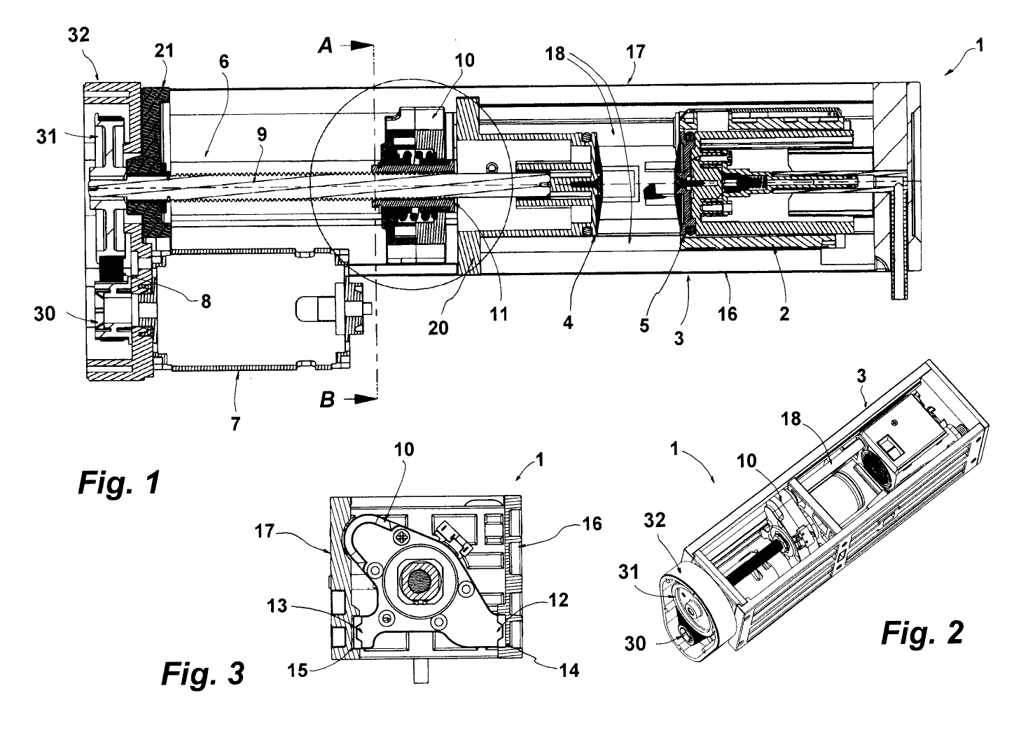

A coffee machine is equipped with a brewing unit 1. As this type of coffee machine is well known in the art, it is not shown. The brewing unit 1 of the depicted embodiment comprises a brewing cylinder 2 that is movable in the direction of the longitudinal axis relative to a frame 3. A segment of the brewing cylinder 2 serves as a brewing chamber for the brewing of coffee in a chosen amount. The brewing cylinder 2 is moved during the various phases of a brewing cycle. The brewing cylinder 2 is moved relative to two pistons 4, 5. The pistons 4, 5 are moved into, out of and within the brewing cylinder 2 in sealed fashion as shown in FIG. 1.

The brewing cylinder 2 is driven by a spindle drive designated as a whole with reference number 6. The spindle drive 6 comprises an electric motor 7 that drives a threaded spindle 9 by means of a tooth belt 8. The spindle 9 is moved in either direction depending on the rotational direction of the electric motor. A drive element 10 is formed as an output nut with a threaded sleeve 11 and sits on the spindle 9. The output element 10 is rotatorily uncoupled relative to the rotational movement of the spindle 9. To this end, the output element 10 is equipped with bearing extensions 12, 13, each of which engages with a guiding groove 14, 15. The guiding grooves 14, 15 follow the longitudinal axis of the brewing unit 1 and are located on a side part 16, 17 of the frame 3 (cf. FIG. 3). The rotatorily uncoupled mounting of the output element 10 has the advantage that when the output element 10 is in its end position on the spindle 9, other than the one shown in FIG. 1, no torque is exerted on the drive rods 18. This means that the drive rods 18 only need to stand up to the shearing and tensile stress required for the movement of the brewing cylinder 2.

The two drive rods 18 are attached to the output element 10 diametrically opposed to each other relative to the spindle 9. The drive rods are attached to the brewing cylinder 2 in shear and tensile-resistant fashion at the other end. During rotational movement of the spindle 9, the output element 10 is moved in a longitudinal direction due to the rotatory uncoupling. The direction of movement depends on the direction of rotation the spindle 9. The brewing cylinder 2 is moved along with the output element 10 via the drive rods 18, bringing it into its various positions during the course of a brewing cycle. The drive rods 18 reach through a frame part 20 connecting the two side parts 16, 17. The drive rods 18 can reach through the frame part 20 with play so that frictional losses are either avoided or reduced to a minimum due to the direct rotatory uncoupling of the output element 10 by the bearing extensions 12, 13 engaging with the guiding grooves 14, 15.

In the depicted embodiment, the adjustment amount of the brewing cylinder 2 and the length of the spindle 9 are coordinated with each other to reduce the installation depth of the brewing unit. In the course of a brewing cycle of the brewing unit 1, the output element 10 is moved from the end position shown in FIG. 1 across the entire longitudinal extension of the spindle 9 all the way to the rear wall 21 of the frame 3 opposite the frame part 20. In the depicted embodiment, the longitudinal movement of the output element 10 is defined by contacts acting on the brewing cylinder 2 moved by the output element 10. The output element 10 is equipped with a cushioning mechanism to assure that the contact motion of the brewing cylinder 2 is cushioned.

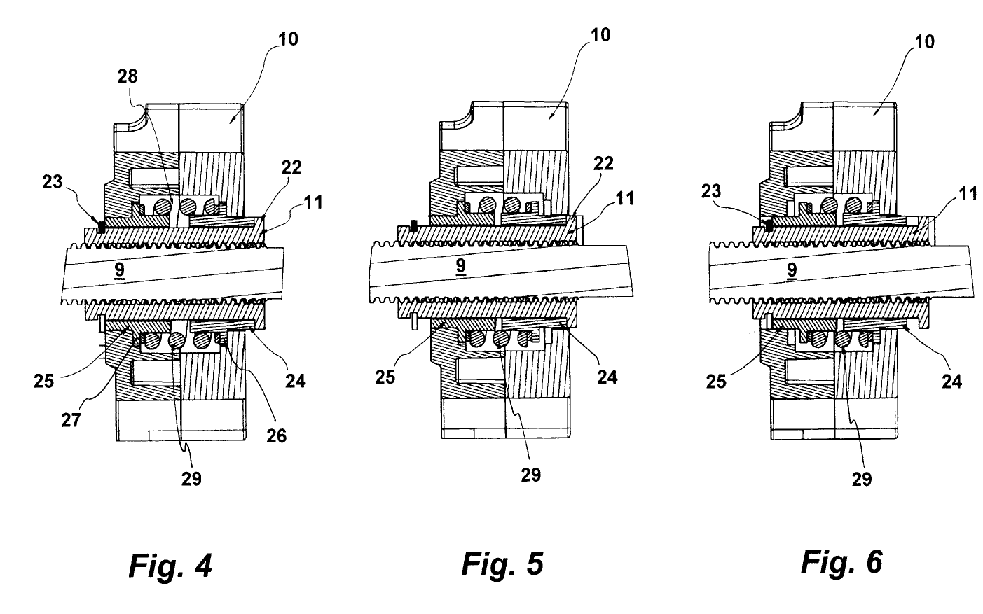

Referring next to FIGS. 4 through 6, the threaded sleeve 11 is adjustable in the output element 10 relative to the other components of the output element 10 in the longitudinal direction. The threaded sleeve 11 has a stop projection 22 protruding outwardly in a radial direction at one of its ends. An additional stop projection 23 is formed by a snap ring placed on the threaded sleeve 11 in the area of the opposite end of the threaded sleeve 22. Two adjusting rings 24, 25 are arranged on the external shell surface of the threaded sleeve 11. The adjusting rings 24, 25 are adjustable in the longitudinal direction relative to the threaded sleeve 11. Each ring 24, 25 has and outwardly projecting flange 26, 27 that extends radially into a chamber 28 of the output element 10.

A helical compression spring 29 is arranged between the flanges 26, 27 of the adjusting rings 24, 25. The spring 29 is supported by the flanges 26, 27 and is under prestress in the neutral position shown in FIG. 4. Thus, the flanges 26, 27 of the two adjusting rings 24, 25 are pressed by the helical compression spring 29 against the end walls of the chamber 28.

The threaded sleeve 11 protrudes from the central channel of the output element 10 on the two flat sides of the output element 10 to accommodate the threaded sleeve 11 and the adjusting rings 24, 25. Together with the helical compression spring 29, these elements form the cushioning element within the output element 10.

The output element 10 sitting on the spindle 9 moves in the corresponding longitudinal direction during a rotatory drive of the spindle 9 in a given direction. The brewing cylinder 2 is moved along in the same manner due to the attached drive rods 18. If brewing cylinder contacts a stop in the course of such a movement, the contact of the brewing chamber 2 with the stop is cushioned by the cushioning element.

The spindle 9 moves the brewing cylinder 2 from its position shown in FIG. 1 to its other end position in when the brewing cylinder 2 is stopped by the frame part 20. As soon as the brewing chamber 2 contacts the side of the frame part 20 facing it, the threaded sleeve 11 continues to be moved by the contact of the brewing chamber 2 with the frame part 20 (which stops any further movement of the brewing cylinder 2 in this direction) against the force of the helical compression spring 29 in the original direction of motion of the output element 10 due to the continuing rotation of the spindle 9 in this direction, as can be seen in FIG. 5. As a consequence of this movement, the adjusting ring 24 has been moved towards the adjusting ring 25. A complete stop contact of the two adjustment rings 24, 25 is avoided since the force provided by the helical compression spring 29 is greater than the maximal force provided by the drive motor 7 in the depicted embodiment. The drive motor shuts itself off automatically in the event of such power consumption. If the spindle 9 is driven in the opposite direction of motion, the output element 10 and the brewing cylinder 2 will move back into the position shown in FIG. 1. If the brewing cylinder 2 is located at the right stop, the movement towards this stop occurs in the same manner as shown in FIG. 6. In this position of the cushioning element, the adjusting ring 25 has been moved by the threaded sleeve 11 towards the adjusting ring 24 against the force of the helical compression spring 29. As seen in FIGS. 5 and 6, the stop flanges 22, 23 are responsible for the motion transport of one or the other adjusting rings 24, 25.

In the depicted embodiment, the electric motor 7 is in a radial arrangement relative to the rotational axis of the spindle 9 as well as to the alignment of the frame 3. The same applies to the drive shaft of the electric motor 7 with its drive wheel 30. The tooth belt 8 that drives the threaded spindle 9 via an output wheel 31 is located on the drive wheel 30. The two wheels 30, 31 as well as the tooth belt 8 are enclosed in a drive gear box 32. The cover provided to close the drive gear box 32 has been removed in FIG. 2 in order to permit a view into the drive gear box 32. FIG. 2 shows that the brewing unit 1 together with its electric motor 7 is constructed in a compact manner, requiring only a relatively minor depth with regard to its installation if it is to be inserted into a coffee machine in horizontal direction from front to rear.

Moreover, the brewing unit 1 is equipped with a hot water supply which in the embodiment shown is delivered to the fixed piston 4 in radial direction. Furthermore, the frame 3 carries a plug connection part in order to be able to connect the brewing unit 1 to the power supply of a coffee machine. Neither connection element is shown in the figures.

While a number of exemplary aspects and embodiments have been discussed above, those of skill in the art will recognize certain modifications, permutations, additions and sub-combinations therefore. It is therefore intended that the following appended claims hereinafter introduced are interpreted to include all such modifications, permutations, additions and sub-combinations are within their true sprit and scope. Each apparatus embodiment described herein has numerous equivalents.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. Whenever a range is given in the specification, all intermediate ranges and subranges, as well as all individual values included in the ranges given are intended to be included in the disclosure. When a Markush group or other grouping is used herein, all individual members of the group and all combinations and subcombinations possible of the group are intended to be individually included in the disclosure.

In general the terms and phrases used herein have their art-recognized meaning, which can be found by reference to standard texts, journal references and contexts known to those skilled in the art. The above definitions are provided to clarify their specific use in the context of the invention.

All patents and publications mentioned in the specification are indicative of the levels of skill of those skilled in the art to which the invention pertains. All references cited herein are hereby incorporated by reference to the extent that there is no inconsistency with the disclosure of this specification. Some references provided herein are incorporated by reference herein to provide details concerning additional starting materials, additional methods of synthesis, additional methods of analysis and additional uses of the invention.

### Reference Sign List

1 brewing unit 31 [sic] drive box
2 brewing cylinder
3 frame
4 piston
5 piston
6 spindle drive
7 electric motor
8 tooth belt
9 spindle
10 drive element
11 threaded sleeve
12 bearing extension
13 bearing extension
14 guiding groove
15 guiding groove
16 side part
17 side part
18 drive rod
20 frame part
21 rear wall
22 stop flange
23 stop flange
24 adjusting ring
25 adjusting ring
26 flange
27 flange
28 chamber
29 helical compression spring
30 drive wheel
31 output wheel

1-15. (canceled)

16. A brewing unit for a coffee machine comprising:
a brewing cylinder with two pistons, wherein at least one of the brewing cylinder and pistons is movable relative to the others by means of a spindle drive
the spindle drive having a threaded spindle and an output element engaging with the thread of the spindle;
the spindle drive moving the at least one moveable part to form a brewing chamber within the brewing cylinder;
the movable element being kinematically connected to the output element via drive rods causing the moveable element to move the same in the direction of a longitudinal axis of the spindle relative to a frame;
an electric motor forming a structural unit with the brewing unit and arranged radially relative to a rotational axis of the spindle so that the brewing unit and the electric motor can be inserted into and removed from a coffee machine as a single unit; and
the output element having at least one bearing extension for a rotation decoupling relative to the spindle, said bearing extension engaging with a guiding groove that follows a longitudinal axis of the brewing unit.

17. The brewing unit of claim 16, wherein the output element has two bearing extensions, at least one of which engages with a guiding groove along the longitudinal axis of the brewing unit.

18. The brewing unit of claim 17, wherein that the drive rods extend through a frame part with free space around the drive rods.

19. The brewing unit of claim 18, wherein the brewing cylinder is the moveable element driven by the spindle drive.

20. The brewing unit of one of claims 16 through 17 wherein the drive shaft of the electric motor is arranged parallel to the rotational axis of the spindle and the electric motor is located in an axial arrangement relative to the rotational axis of the spindle.

21. The brewing unit of claim 19, further comprising that the electric motor drives the spindle by means of a toothed drive belt.

22. The brewing unit of claim 21, wherein the elements provided for the transmission of power from the drive shaft of the electric motor to the spindle are enclosed in a drive gear box.

23. The brewing unit in accordance with one of claims 16 through 17, wherein the output element comprises a threaded sleeve that engages with the thread of the spindle and wherein the threaded sleeve is mounted in the output element such that the threaded sleeve movable by a given amount relative to the output element in the direction of the longitudinal axis of the brewing unit against the force of a spring element.

24. The brewing unit in accordance with claim 23, wherein the spring element is a helical compression spring enclosing the threaded sleeve.

25. The brewing unit in accordance with claim 24 further comprising:
two adjusting rings each with a flange extending in a radial direction, the adjusting rings mounted on an exterior surface the threaded sleeve;
the adjusting rings being movable in the direction of the longitudinal axis and wherein the helical compression spring is supported by both flanges;
the helical compression spring is held under prestress between the flanges; and
the threaded sleeve further comprises blocking extensions extending outward in axial direction in the area of its ends such that during a movement of the threaded sleeve relative to the output element or to the adjustment rings in the direction of the longitudinal axis are stopped in one direction by one of the adjustment rings in one direction and by the other adjustment ring in the other direction.

26. The brewing unit in accordance with claim 25, wherein the adjustment rings together with their flanges are arranged in a chamber of the output element.

27. The brewing unit of claim 26, wherein the brewing unit is removable or insertable from the coffee machine in a horizontal direction.

29. The brewing unit of claim 23, wherein the output of the electric motor used to drive the spindle is less than the counteracting force provided by the maximal force of the spring element.
